(19) United States
(12) Patent Application Publication
(10) Pub. No.: US 2010/0313536 A1
(43) Pub. Date: Dec. 16, 2010

(54) DOUBLE CUT LAWNMOWER ATTACHMENT

(76) Inventor: RON BERKO, Grants Pass, OR (US)

Correspondence Address: LAW OFFICE OF JERRY D. HAYNES , P.A, P.O. Box 350392, Fort Lauderdale, FL, 33335, US

(21) Appl. No.: 12/483,219

(22) Filed: Jun. 11, 2009

(51) Int. Cl. A01D 34/00

(52) U.S. Cl. 56/12.7

(57) ABSTRACT

The present invention relates to a cutting attachment to increase the cutting swath of a riding mower comprising: an attachment mechanism, where said attachment mechanism secures the cutting attachment to a sleeve hitch of a riding lawnmower; a plurality of cutting blades, where said cutting blades rotate vertically; a motor that drives a pulley system, where said pulley system rotates the cutting blades; a battery, where the battery supplies power to the motor; and a plurality of casters, where said casters support the cutting attachment. The cutting attachment may also include a deck that provides an outlet for cut grass. The castors may be positioned on the outer perimeter of the cutting attachment and include a mechanism to adjust the cutting height of the cutting attachment.

### BACKGROUND OF THE INVENTION

1. Field of Invention

The present invention relates to an attachment for a riding lawnmower that increases cutting capacity.

2. Description of Related Art

Lawnmowers have been utilized to cut lawns since the late 1800s. Lawnmowers are especially helpful in maintaining playing fields, public parks and other large acreages of grass. The most common type of lawnmower is a rotary lawnmower, where the cutting blades rotate about a vertical axis within a housing. Rotary mowers may be powered by gas or electricity. The mowers currently used include push mowers and riding lawnmowers. Smaller push mowers are used for residential homes and some commercial lawns depending on size. Ideally the smaller push mowers are more conducive for smaller lawns that require more maneuverability that is available with a push mower. Larger acreage requires the use of riding lawnmowers in order to expedite the cutting thereof. The increased acreage also would be very laborious for an individual using a push lawnmower.

Various attachments have been developed for use on riding lawnmowers to assist in the cutting of lawns. The attachments include trimming attachments, raking attachments, mulching, cutting devices and sweepers that increase the cutting width or capacity of the riding lawnmower. Sweepers increase the cutting capacity of the riding lawnmower as it's driven over a lawn. By increasing the width or size of a cut with one sweep, the user of a riding lawnmower can therefore diminish the amount of time associated with cutting a large lawn. Attachments that increase the cutting swath of a lawnmower can provide the user with a more efficient use of a riding lawnmower.

### SUMMARY OF THE INVENTION

The present invention relates to a cutting attachment to increase the cutting swath of a riding mower comprising: an attachment means where said attachment means secures the cutting attachment to a sleeve hitch of a riding lawnmower; a plurality of cutting blades, where said cutting blades rotate vertically; a motor that drives a pulley system, where said pulley system rotates the cutting blades; a battery, where the battery supplies power to the motor; and a plurality of casters, where said casters support the cutting attachment. The cutting attachment may also include a deck that provides an outlet for cut grass. The castors may be positioned on the outer perimeter of the cutting attachment and include a means to adjust the cutting height of the cutting attachment. In one exemplary embodiment, the cutting attachment may also include at least two hinges where the hinges provide a means to collapse the cutting attachment for storage purposes.

### DESCRIPTION OF DRAWINGS

FIG. 1 depicts a cutting attachment according to the present invention.

### DETAILED DESCRIPTION

The present invention provides a cutting attachment that is easily attached to a riding lawnmower. The cutting attachment according to the present invention increases the width of a cutting swath of a normal riding lawnmower. The increased cutting swath therefore reduces the amount of time required to cut a lawn and provides for a more efficient use of a riding lawnmower.

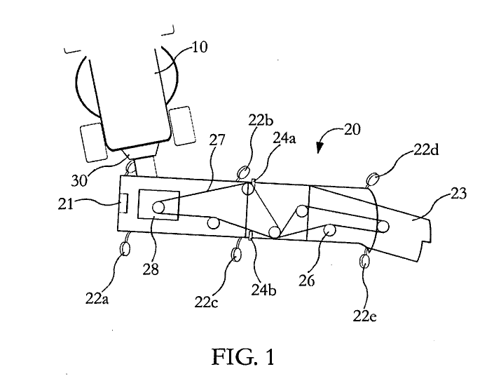

The cutting attachment depicted in FIG. 1 attaches to a sleeve hitch 30 that extends from the front end of a riding lawnmower 10. The sleeve hitch 30 extends horizontally from the front end of the riding lawnmower and provides a means to attach the cutting attachment 20. The cutting attachment 20 increases the cutting swath of the riding lawnmower 10. The increased swath therefore increases the cutting capacity of the riding lawnmower.

The cutting attachment 20 includes a plurality of castors 22a, 22b, 22c, 22d, 22e, 22f. The castors 22a-22f are placed along each respective side of the cutting attachment 20. The swivel castors 22a-22f provide a means for the movement of the cutting attachment as the riding mower 10 is maneuvered across a lawn. The castors 22a-22f support the cutting attachment 20 and enable the smooth movement of the cutting attachment to across the objective lawn. The height of the cutting attachment 20 may be adjusted in order to coincide with the cutting height of the riding mower 10.

Other components of the cutting attachment 20 include a battery 21 that provides power to the cutting attachment in order to power the cutting mechanisms provided therein. An electrical motor 28 turns the pulley system within the cutting attachment 20 that rotates the cutting blades within the cutting attachment. Hinges 24a, 24b are positioned at the center of the cutting attachment 20, which provide a means to fold the cutting attachment for storage when not in use. The cutting attachment 20 attaches to the sleeve hitch 30 of the lawnmower. The sleeve hitch 30 extends outwardly onto the attachment means provided by the cutting attachment 20, where the attachment means may include a pin. The cutting attachment 20 also includes a deck 23 that extends outwardly and provides an outlet for cut grass as it is maneuvered across the lawn during the cutting process.

The cutting attachment 20 remains in a stationary position as the lawnmower 10 is maneuvered across a lawn. A tensioner 26 is provided along the pulley system within the cutting attachment in order to tighten and adjust the pulley system provided within the cutting attachment 20. The pulley system rotates the cutting blades within the cutting attachment wherein the rotating blades cover the entire width of cut provided by cutting attachment 20.

By utilizing the cutting attachment 20, an individual may be able to increase the cutting swath and in some cases even double the available cutting swath as provided by a riding lawnmower. By this increase in cutting swath the cutting attachment can therefore reduce cutting time in half in some instances.

1. A cutting attachment to increase the cutting swath of a riding mower comprising:
a. an attachment means where said attachment means secures the cutting attachment to a sleeve hitch of a riding lawnmower, where the hitch extends from the front end of the lawnmower;
b. a plurality of cutting blades, where said cutting blades rotate vertically;
c. a motor that drives a pulley system, where said pulley system rotates the cutting blades;
d. a battery, where the battery supplies power to the motor; and
e. a plurality of casters, where said casters support the cutting attachment.

2. The cutting attachment according to claim 1, further including a deck that provides an outlet for cut grass.

3. The cutting attachment according to claim 1, further including a tensioner where said tensioner provides a means to adjust the tension of the pulley system.

4. The cutting attachment according to claim 1, where the castors are positioned on the outer perimeter of the cutting attachment.

5. The cutting attachment according to claim 1, further including at least two hinges where the hinges provide a means to collapse the cutting attachment for storage purposes.

6. (canceled)

7. A cutting attachment according to claim 1, where said sleeve hitch is a single column that provides for the placement and securing of the cutting attachment in a stationary position.

8. A cutting attachment according to claim 1, where the cutting attachment extends substantially perpendicular to the sleeve hitch.
